(19) United States
(12) Patent Application Publication
(10) Pub. No.: US 2006/0078488 A1
(43) Pub. Date: Apr. 13, 2006

(54) Carbon material and process for producing the same

(75) Inventors: Koji Suemura, Yokohama-shi (JP); Tetsuo Kasai, Yokohama-shi (JP)

Correspondence Address: NIXON & VANDERHYE, PC, 901 NORTH GLEBE ROAD, 11TH FLOOR, ARLINGTON, VA, 22203, US

(73) Assignee: FRONTIER CARBON CORPORATION, Tokyo (JP)

(21) Appl. No.: 11/032,224

(22) Filed: Jan. 11, 2005

(30) Foreign Application Priority Data
Jan. 14, 2004 (JP) 2004-006935

(51) Int. Cl. C01B 31/02

(52) U.S. Cl. 423/445 R

(57) ABSTRACT

There are provided a novel carbon material having a characteristic property of a high volume electrical resistance, which is different from conventional carbon black.

A carbon material of the present invention is insoluble in organic solvents, and has a peak height ratio H(B)/H(A) and a peak strength ratio I(D)/I(G) which are fall within the region defined by four points: (X, Y)=(0.86, 0.71), (0.65, 0.86), (0.28, 0.59) and (0.23, 0.63) in the coordinate system shown in FIG. 1 where the peak height ratio H(B)/H(A) is plotted as the X-axis and the peak strength ratio I(D)/I(G) as the Y-axis, wherein H(A) represents a height of the strongest peak at the diffraction angle 2 θ of 12-16° and H(B) represents a height of the peak at 2 θ=22° in the X-ray diffractometry using CuKα-rays, and I(G) represents a peak strength in the band of G1590±20 cm⁻¹ and I(D) represents a peak strength in the band D1340±40 cm⁻¹ in the Raman spectrometry at the excitation wavelength of 5145 Å.

### PRIORITY CLAIM

The priority application No. 2004-006935 filed on Jan. 14, 2004 upon which this application is based is hereby incorporated by reference.

### BACKGROUND OF THE INVENTION

The present invention relates to a carbon material and a process for producing the same. More particularly, the present invention relates to a novel carbon material having a characteristic property of a high volume electrical resistance, which is different from conventional carbon material such as carbon black, and a process for producing the novel carbon material.

Carbon black as a typical carbon material has many advantageous properties such as light weight, heat resistant, electroconductive, chemical resistant or the like, and has been used for various purposes. Also, the carbon black has been added in plastics, rubbers, solvents, etc., as a pigment, a light stabilizer, a conductivity imparting agent or a filler, and has been applied to the products of common use, such as various kinds of ink, toner, resins, tires, etc., as well as to the specific uses such as brakes for racing cars, aircraft, etc. The carbon black has also been used in the field of information electronics, for instance, as a material for ink for inkjet printing, e-paper (a novel device for forming an image by making use of the property of microencapsulated carbon black and titania which are charged to opposite polarity), electrodes, conductive resins, etc.

However, since carbon black is conductive, it needs to get rid of conductivity from carbon black and to impart insulating properties to carbon black for the application to the parts which are required to be insulating or to the uses in the field where electrical charging is utilized. Therefore, it is essential to conduct an after-treatment such as a resin adhesion or the like so as to coat with a resin on the product surface (Japanese Patent Application Laid-open No. 11-60988). In this case, there arises a problem which inevitably leads to a rise of cost. Also, there also arises the problem of insufficient insulation due to difficulty of perfect coating.

### SUMMARY OF THE INVENTION

An object of the present invention is to provide a novel carbon material having a characteristic property which is high in volume electrical resistance, which is different from conventional carbon black.

In a first aspect of the present invention, there is provided a carbon material which is insoluble in organic solvents and has a peak height ratio H(B)/H(A) of 0.2 to 0.9, wherein H(A) represents a height of the strongest peak at the diffraction angle 2 θ of 12-16° and H(B) represents a height of the peak at 2 θ=22° in the X-ray diffractometry using CuKα-rays.

In a second aspect of the present invention, there is provided a carbon material which is insoluble in organic solvents, and has a peak height ratio H(B)/H(A) and a peak strength ratio I(D)/I(G) which fall within the region defined by four points: (X, Y)=(0.86, 0.71), (0.65, 0.86), (0.28, 0.59) and (0.23, 0.63) in the coordinate system shown in FIG. 1 where the peak height ratio H(B)/H(A) is plotted as the X-axis and the peak strength ratio I(D)/I(G) as the Y-axis, wherein H(A) represents a height of the strongest peak at the diffraction angle 2 θ of 12-16° and H(B) represents a height of the peak at 2 θ=22°, in the X-ray diffractometry using CuKα-rays, and I(G) represents a peak strength in the band of G1590±20 cm⁻¹ and I(D) represents a peak strength in the band D1340±40 cm⁻¹ in the Raman spectrometry at the excitation wavelength of 5145 Å.

In a third aspect of the present invention, there is provided a process for producing the carbon material as defined in the first or second aspect, comprising feeding a hydrocarbon-containing compound as a raw material and an oxygen-containing gas into a reaction furnace through delivery ports provided in the reaction furnace to burn the hydrocarbon-containing compound, collecting soot as produced, and contacting the collected soot with an organic solvent, wherein upon producing the soot, the hydrocarbon-containing compound and the oxygen-containing gas are delivered through the respective delivery ports at average delivery rates of from more than 75 cm/sec to 1,000 cm/sec, while maintaining an inside pressure of the reaction furnace in the range of 20 to 100 Torr, and upon burning the hydrocarbon-containing compound, an atomic ratio of carbon element in the hydrocarbon-containing compound to oxygen element in the oxygen-containing gas is set to the range of 0.89 to 1.56.

According to the present invention, there is provided a novel carbon material having the property of a high volume electrical resistance, which is different from conventional carbon black. The carbon material of the present invention is particularly expected the application to uses where a high-resistance carbon material is required, for instance, color filter-on-array which is a new technique for liquid crystal display. Also, as the carbon material exhibits a good electrostatic charging property, there is highly expected the application to uses where the electrostatic charging property of carbon black is utilized, such as copying toner having carbon black dispersed in a resin, e-paper or the like. Further, because of the supposedly low heat conductivity, this carbon material is expected to be utilized as a filler in coating compositions used for the products which are required to be heat insulating.

### BRIEF DESCRIPTION OF THE DRAWINGS

FIG. 1 shows the structural domain of the novel carbon material of the present invention defined by the result of X-ray diffractometry, H(B)/H(A), and the result of Raman spectrometry, I(D)/I(G).

FIG. 2 is a transmission electron micrograph with a scale of 5.0 nm showing an amorphous structure of the novel carbon material according to the present invention.

FIG. 3 is a transmission electron micrograph with a scale of 2.0 nm showing an amorphous structure of the novel carbon material according to the present invention.

FIG. 4 is an X-ray diffraction chart of the novel carbon material of the present invention.

FIG. 5 is a Raman spectrum of the novel carbon material of the present invention.

FIG. 6 is an X-ray diffraction chart of a commercial carbon black.

FIG. 7 is a Raman spectrum of the commercial carbon black.

### DETAILED DESCRIPTION OF THE INVENTION

The present invention is described in detail below.

<Carbon Material>

In the carbon material of the present invention, the carbon content as determined by elemental analysis is usually not less than 90% by weight, preferably not less than 95% by weight. Further, the carbon material may contain small amounts of functional groups such as hydroxyl and carboxyl groups as well as carbon black.

The carbon material of the present invention is powder composed of an aggregate and/or agglomerate of primary particles having a particle diameter of 1 to 100 nm.

The carbon material of the present invention is insoluble in organic solvents. The organic solvents include, for example, aromatic hydrocarbons, aliphatic hydrocarbons and chlorinated hydrocarbons. The preferred organic solvents from the industrial standpoint are ones which are liquid at an ordinary temperature and have a boiling point at 100 to 300° C., preferably 120 to 250° C. For example, aromatic hydrocarbons such as benzene, toluene, xylene, methysilene, 1-methylnaphthalene, 1,2,3,5-tetramethylbenzene, 1,2,4-trimethylbenzene and tetrahydronaphthalene may be exemplified. Among these aromatic hydrocarbons, 1,2,4-trimethylbenzene and tetrahydronaphthalene are preferred. As the property of the carbon material which is insoluble in organic solvents, the weight difference of the carbon material treated by the following method from that before the treatment is usually not more than 5%, preferably not more than 3%, more preferably not more than 1%, when 1,2,4-trimethylbenzene in an amount of 90 times by weight based on the weight of the carbon material is added to the carbon material at room temperature, and after stirring well and filtering, the obtained carbon material is vacuum dried at 150° C. for 10 hours.

The carbon material according to the present invention has an entirely novel internal structure which has been absent in the conventional carbon materials. This internal structure can be specified by the results of X-ray diffractometry using CuKα-rays (wavelength=1.54 Å) and the results of Raman spectrometry at the excitation wavelength of 5,145 Å.

As the results of X-ray diffractometry, the carbon material of the present invention has peak A (maximal point at diffraction angle 2 θ=12-160) and peak B (2 θ=220) on the diffraction spectrum. In the conventional carbon black, there is observed a diffraction peak due to 002 reflection (lattice spacing: 3.3-3.9 Å) at diffraction angle of 23-27° with the development of the micro-graphite structure. On the contrary, in the carbon material of the present invention, there is observed no corresponding peak, or even if there exists a peak, the peak strength thereof is weaker than that of the peak existing in the diffraction angle of 12 to 16°. The diffraction angle 2 θ=12 to 16° is equivalent to 5.5 to 7.4 Å (calculated as a ‘d’ value of lattice spacing). The carbon material of the present invention has a mild periodic structure with a constant spacing of about 6 to 7 Å, but the structure thereof differs from that of the conventional carbon black in points of no micro-graphite structure. On the basis of the above facts, the carbon material of the present invention has a property which is high in volume electrical resistance, and as a result, a low heat conductivity of the carbon material of the present invention is presumed.

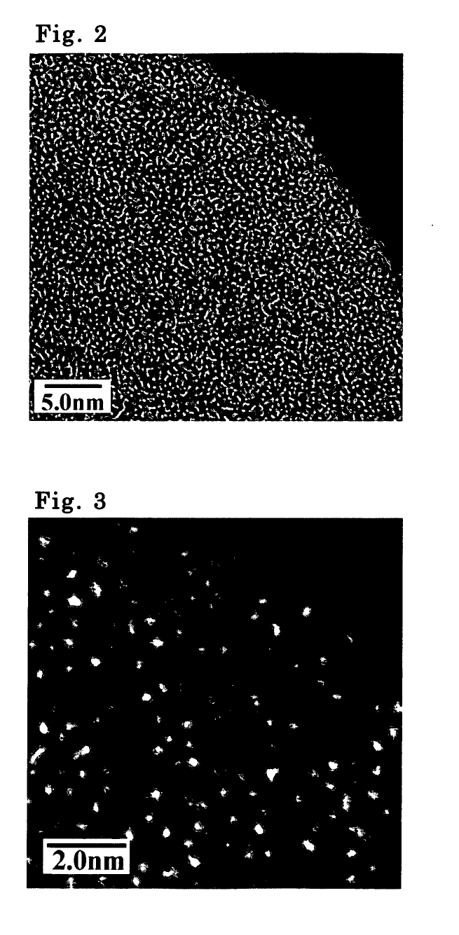

As seen from the transmission electron microscopic (TEM) photographs (FIGS. 2 and 3) of the carbon material of the present invention, there is observed as a mixed phase composed of principally an amorphous structure having a mild periodicity with a constant spacing of about 6 to 7 Å and a small amount of onion structure (called Bucky onion or carbon onion), and there is substantially not observed a micro-graphite structure as seen in conventional carbon black. As seen from the results of the X-ray diffractometry, the onion structure is observed as a broad diffraction ray at a diffraction angle close to 22°, and although not conspicuous as the micro-graphite structure, the onion structure acts to reduce the volume electric resistance and has an effect as an inhibitory component. Therefore, as an index of the mixing ratio of the onion structure to the amorphous structure, the peak height ratio H(B)/H(A) in X-ray diffractometry is preferably not more than 0.9, more preferably not more than 0.5. The lower limit of the peak height ratio H(B)/H(A) is preferably 0.2.

In Raman spectrometry at the excitation wavelength of 5145 Å, the carbon material of the present invention shows peaks in the band of G1590±20 cm⁻¹ and the band of D1340±40 cm⁻¹ on the spectrum. When the peak strength in the respective bands is I(G) and I(D), the upper limit of the peak strength ratio I(D)/I(G) is usually 0.9, preferably 0.7, and its lower limit is usually 0.6.

On the basis of the facts that there are the peaks in the bands of G1590±20 cm⁻¹ and D1340±40 cm⁻¹, and that the peak strength ratio I(D)/I(G) is less than 1, it is understood that the ordinary carbon materials are of a micro-graphite structure (G) with high regularity at a relatively high percentage, and edge carbon (D) is small in percentage. On the contrary, in the case of the carbon material of the present invention, as mentioned above, on the basis of the fact that there exists no diffraction peak due to 002 reflection at the diffraction angle of 23-27° or there exists the diffraction peak only slightly, if any, in X-ray diffractometry, it is considered that the structure observed in both bands G and D on the Raman spectrum is constituted by an aromatic plane (G) derived from a periodic amorphous structure and onion structure, and edge carbon (D).

In the case where an onion structure or any heterostructure such as edge carbon is contained in the carbon material, an increase in electric conductivity thereof tends to be induced from such a structure as a base point, resulting in deteriorated electric resistance thereof. For this reason, when observing conductive electrons derived from these structures by an electronic paramagnetic resonance (EPR) method, the difference between the carbon material of the present invention and the conventionally known carbon materials can be readily distinguished.

In addition, in the carbon material of the present invention, the balance of the result of X-ray diffractometry and the result of Raman spectrometery influences a volume electrical resistance. That is, when the peak strength ratio H(B)/H(A) from the result of X-ray diffractometry is plotted on the X-axis and the peak strength ratio I(D)/I(G) from the result of Raman spectrometry is plotted on the Y-axis, then the coordinates (X,Y) fall within the region encompassed by the following four points: usually (0.86, 0.71), (0.65, 0.86), (0.28, 0.59) and (0.23, 0.63), preferably (0.66, 0.67), (0.52, 0.79), (0.28, 0.59) and (0.23, 0.63), more preferably (0.47, 0.63), (0.37, 0.71), (0.28, 0.59) and (0.23, 0.63). When the coordinates (X,Y) are out of the above-mentioned region, it is presumed that the industrial value thereof is low because of low volume electrical resistance or difficulties to obtain the carbon material. The peak height ratio H(B)/H(A) from the result of X-ray diffractometry and the peak strength ratio I(D)/I(G) from the result of Raman spectrometry provide the indices of the different viewpoints: physical periodic structure by the arrangement of carbon atoms and the percentage of chemical faults contained in a given carbon arrangement. Since the percentage of faults contained in the same kind of carbon arrangement is not always constant, it is considered that X and Y do not necessarily hold a fixed linear relation.

<Production Process of Carbon Material>

The carbon material of the present invention can be easily produced by a process in which a hydrocarbon-containing compound as a raw material and an oxygen-containing gas are fed into a reaction furnace from the respective delivery ports provided in the reaction furnace to burn the hydrocarbon-containing compound, and then the obtained soot is collected (recovered) and brought into contact with an organic solvent to remove impurities such as polycyclic aromatic compounds from the soot. More specifically, the process for producing the carbon material of the present invention comprises the steps of burning the hydrocarbon-containing compound such as a hydrocarbon-containing gas in burner flames under reduced pressure, cooling the obtained soot while being guided to a vacuum pump, collecting (recovering) the soot by a dust collector such as a high temperature heat resistant filter, removing by extraction the organic solvent-soluble substances contained in the collected soot, and then filtering and drying the obtained material.

The soot production process is generally called a combustion method. As the apparatus therefor, for example, an apparatus in which a (water-cooled) burner is set in a vacuum chamber, are used for allowing stable continuous combustion while evacuating the system with a vacuum pump. As the burner, there is used a burner having a structure which is capable of realizing both the premix laminar flow flames and the diffusion flames of the hydrocarbon-containing gas such as benzene and an oxygen-containing gas.

Upon the production of the soot by the above combustion method, it is important that the average delivery rate of the hydrocarbon-containing gas and the oxygen-containing gas from the respective delivery ports are set to be more than 75 cm/sec and not more than 1,000 cm/sec, the pressure in the reaction furnace is set at 20 to 100 Torr, and the elemental compositional atomic ratio of carbon in the hydrocarbon-containing gas to oxygen in the oxygen-containing gas upon the combustion of the hydrocarbon-containing gas is set in the range of 0.89 to 1.56.

It is preferred that the upper limit of the average delivery rate (gas rate) of the hydrocarbon-containing gas and oxygen-containing gas into the reaction furnace from the delivery ports is 300 cm/sec. It is preferred that the upper limit of the elemental compositional ratio (C/O ratio) of carbon in the hydrocarbon-containing gas to oxygen in the oxygen-containing gas upon the combustion of the hydrocarbon-containing gas is 1.05.

In the techniques for production of carbon materials, the control of the C/O ratio means the control of the flame temperature. In general, upon incomplete combustion, the lower the C/O ratio, the higher the maximum temperature within flame. When the temperature is too high, since the amorphous structure is converted into an onion structure, an optimum temperature range (i.e., an optimum C/O ratio) exists for production of carbon materials.

Also, in general, a temperature distribution in flame exists in the sectional direction thereof. However, the flame temperature distribution in the sectional direction thereof seems to become more moderate when the average delivery rate (gas velocity) becomes larger than a certain level. Therefore, it is suggested that the increased average delivery rate is effective to attain a uniform structure of the carbon material.

Accordingly, when the above flame conditions can be satisfied at the same time, it becomes possible to produce the novel carbon material according to the present invention.

In the process of the present invention, it is not essential to use a diluent. As the diluent, usually an ordinary inert gas, preferably argon gas is used. The upper limit of the concentration of the diluent is usually 40 mol %.

The soot formed in combustion contains impurities such as polycyclic aromatic compounds along with the novel carbon material of the present invention. Therefore, these impurities are removed by usually extraction or washing with an organic solvent. The organic solvent to be used for the removal of impurities is not specified in the present invention, but it is preferable to use organic solvents in which the carbon material of the present invention is insoluble, such as mentioned above.

In extraction, an organic solvent is mixed with the soot and then the carbon material is separated from the organic solvent and recovered. As extractor, industrially a stirring mixer is preferably used. Pressure in the vessel in the extraction operation is not specifically limited, but usually the inside of the vessel is kept under normal pressure. Extraction temperature is usually in the range of 10 to 90° C., preferably 15 to 40° C., more preferably 25 to 35° C. Extraction time is usually 1 to 60 minutes, preferably 20 to 40 minutes. Extraction may be carried out while applying ultrasonic waves to the extraction solution for shortening the extraction time. The amount of the organic solvent can be also selected properly, but usually the weight ratio of the soot to the organic solvent is selected to be between 4 and 200. Too much amount of organic solvent may cause to a rise of cost, while too small amount of organic solvent may cause insufficient contact thereof with the soot, resulting in imperfect extraction. Separation of the carbon material from the organic solvent is usually conducted by one or more of the following techniques: filtration under reduced pressure, filtration under pressure, centrifuging and precipitation. In order to obtain a stable carbon material, the carbon material is preferably exposed to atmosphere after being dried and cooled to a temperature of not more than 100° C. Specifically, it is more preferred that the carbon material thus separated and recovered is further dried in an inert gas, and then after cooling to 100° C. or less, exposed to atmosphere. This is because when the carbon material is heated to a temperature of not less than 110° C. in atmosphere (air), air oxidation thereof tends to be undesirably caused. As an industrially preferred dryer, a material stirring-type dryer may be exemplified. The above extracting operation may be conducted repeatedly.

<Function of Carbon Material>

The carbon material of the present invention shows a high volume electrical resistance. For instance, under a condition where 1 g of sample is packed in a 2 cm diameter cylindrical cell with four-probe electrodes and a pressure of 120 kgf/cm² is applied thereto, the volume electrical resistance of the carbon material is usually not less than 1 Ω·cm, preferably not less than 10 Ω·cm, more preferably not less than 10⁵ Ω·cm.

The carbon material of the present invention is suited for uses where a high-resistance carbon material is required, such as color filter-on-array which is a novel technique for liquid crystal display. Also, as the carbon material of the present invention shows good charging properties, the carbon material of the present invention can be used as a substitute of carbon black, copying toner, e-paper, etc. Further, as the carbon material of the present invention is usually low in heat conductivity, the carbon material of the present invention can be utilized as a filler in coating compositions for the heat insulating articles.

### EXAMPLES

The present invention is described in more detail by Examples, but the Examples are only illustrative and therefore, not intended to limit the scope of the present invention. Evaluation of the obtained carbon materials and determination of the properties thereof were conducted as explained below.

(1) X-Ray Diffractometry

X-ray diffractometry was conducted using a diffractometer (“PW1700”, manufactured by Phillips Corporation) under the following conditions: ray source: CuKα; output: 40 kV 30 mA; scanning axis: θ/2θ; measuring mode: Continuous; measuring range: 2θ=3-90°; spec width: 0.05°; scanning speed: 3.0°/min.

(2) Raman Spectrometry

Raman spectrum measurement was conducted using a spectrometer (“NR1800”, manufactured by JASCO Corporation) the following conditions: excitation wavelength: 5,145 Å; excitation output: not more than 5 mW; exposure time: 50 sec.; number of times of integration: 2, with the sample back scattered. A straight base line was drawn in the range of 1,740-1,165 cm⁻¹, and the height up to the peak top was determined and expressed as peak strength.

(3) Volume Electrical Resistance

The volume electrical resistance was measured by using a powder resistance measuring system (“MCP-PD51”, manufactured by Dia Instruments Co., Ltd.). The sample was ground by a ball mill to measure the volume electrical resistance. One gram of the ground specimen was filled in a cylindrical cell having a diameter of 2 cm, with four-probe electrodes, and a pressure of 120 kgf/cm² was applied to the specimen. Under this condition, thickness and resistivity of the specimen were determined and the volume electrical resistance (Ω·cm) was calculated from their determined values.

### Example 1

Using an apparatus having a premixing-type water-cooled burner installed to a vacuum chamber, a raw material (toluene) and oxygen were premixed, and supplied to the burner while evacuating the system by a vacuum pump to form stable laminar flames. Combustion was carried out under the conditions of: C/O ratio=1.01:1; pressure in the combustion chamber=40 Torr; gas flow rate=76 cm/sec; and no argon dilution. The produced soot was cooled to 400-500° C. in the conduit while transferring the produced soot to the vacuum pump and collected by a bag filter set in front of the vacuum pump.

10.30 g of the collected soot was weighed out in a one-litre measuring flask, 286.2 g of tetraphosphorus was added thereto, and the obtained mixture was stirred at an ordinary temperature while applying ultrasonic waves for 30 minutes and then filtered under pressure by a 0.45 μm filter to remove the soluble matter. Removal of soluble matter with tetraphosphorus was further repeated 3 times, then subjected to vacuum drying at 150° C. for a whole day and night, cooled to not more than 100° C., and exposed to the atmosphere to obtain 9.27 g of black powder (hereinafter referred to “carbon material”). Carbon yield after solvent extraction was 90%.

To 9.60 g of thus obtained carbon material, 889 g of 1,2,4-trimethylbenzene was added at room temperature and the obtained mixture was stirred well, filtered and then vacuum dried at 150° C. for 10 hours. The weight of the carbon material after the above treatment was 9.60 g. It was confirmed that the obtained carbon material was substantially insoluble in the organic solvents. Elemental analysis of this carbon material showed a carbon content of 97% by weight and an oxygen content of 2.4% by weight. The obtained carbon material was powder composed of an aggregate and/or agglomerate of primary particles having a particle diameter of 1 to 100 nm.

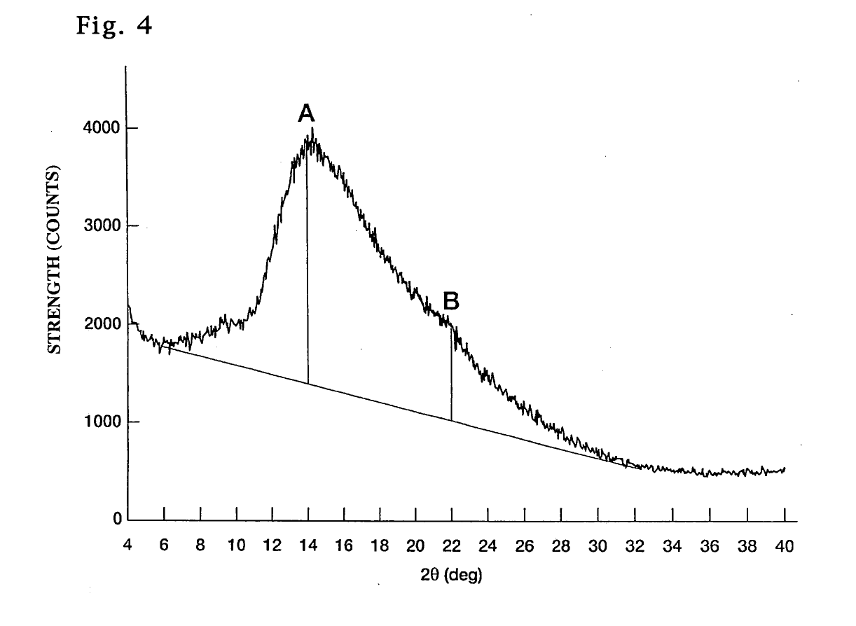

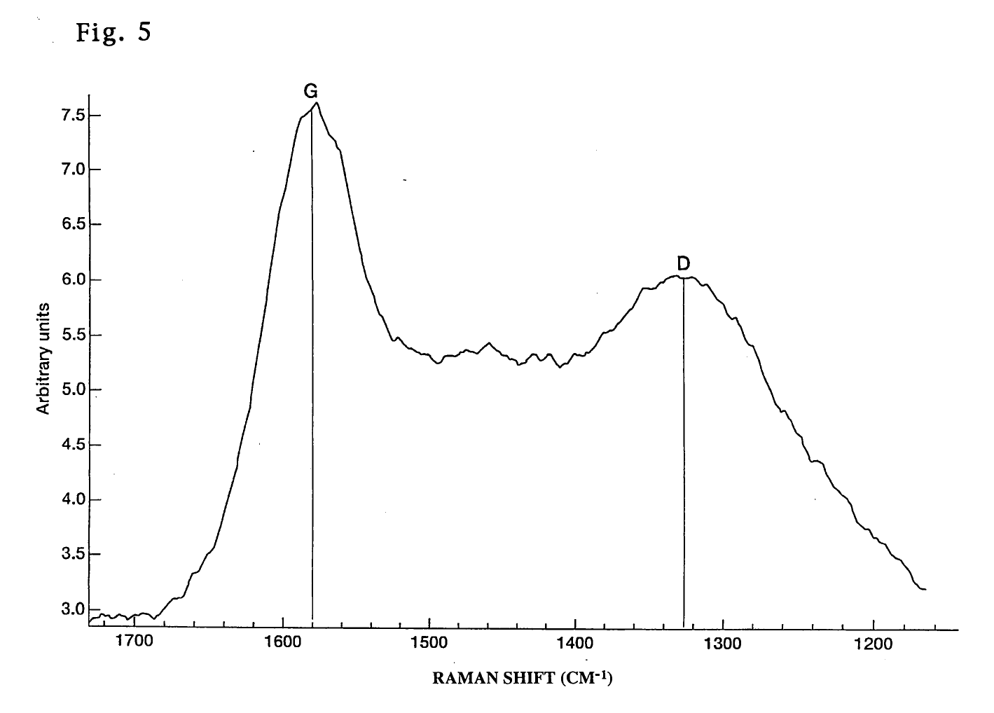

In X-ray diffraction of the carbon material, there was observed a strong peak (A) a diffraction angle close to 14°, and the height ratio of this peak to the peak (B) at the diffraction angle of 22°, H(B)/H(A), was 0.38. It was thus found that the graphite peak at the diffraction angle around 23-27° is very weak, which indicated that this material is substantially amorphous (see FIG. 4). In the Raman spectrum (FIG. 5), there were peaks at 1,580 cm⁻¹ and 1,330 cm⁻¹, with the peak strength ratio I(D)/I(G)=0.63 and the coordinates (X, Y)=(0.38, 0.63). Volume electrical resistance of the carbon material was 8.9×10⁵ Ω·cm (under pressure of 120 kgf/cm²).

### Examples 2-5

The same procedure as defined in Example 1 was conducted except of using the conditions shown in Table 1, thereby obtaining carbon materials. The property values of the obtained carbon materials are shown in Table 1. Also shown in Table 1 is volume electrical resistance (under pressure of 120 kgf/cm²) of these carbon materials. (Meanwhile, the operational conditions of Example 3 were considerably changed from the condition of Example 5. More specifically, in Example 3, the flow rate was reduced from 305 cm/sec to 76 cm/sec, and the C/O atomic ratio was reduced from 1.15 to 1.01. In any of Examples 1 to 5, the materials were sampled after 6 hours from ignition of the respective experiments.)

TABLE 1

| | | | Pressure in |
|---|---|---|---|
| | | | combustion |
| | Gas flow rate | | chamber |
| | (cm/sec) | C/O ratio | (Torr) |
| Example 1 | 76 | 1.01 | 40 |
| Example 2 | 305 | 1.01 | 40 |
| Example 3* | 76 | 1.01 | 40 |
| Example 4 | 76 | 1.15 | 40 |
| Example 5 | 305 | 1.15 | 40 |

(Note)
*Although the operational conditions were considerably changed, the
material was sampled after 6 hours similarly to the other Examples.

| | | | Volume |
|---|---|---|---|
| | | | electrical |
| | XRD | Raman spectrum | resistance |
| | H(B)/H(A) | I(D)/I(G) | (Ω · cm) |
| Example 1 | 0.38 | 0.63 | 8.9 × 10⁵ |
| Example 2 | 0.41 | 0.65 | 7.7 × 10⁵ |
| Example 3 | 0.42 | 0.69 | 2.5 × 10² |
| Example 4 | 0.49 | 0.67 | 3.3 × 10 |
| Example 5 | 0.78 | 0.73 | 3.9 |

### Referential Example 1

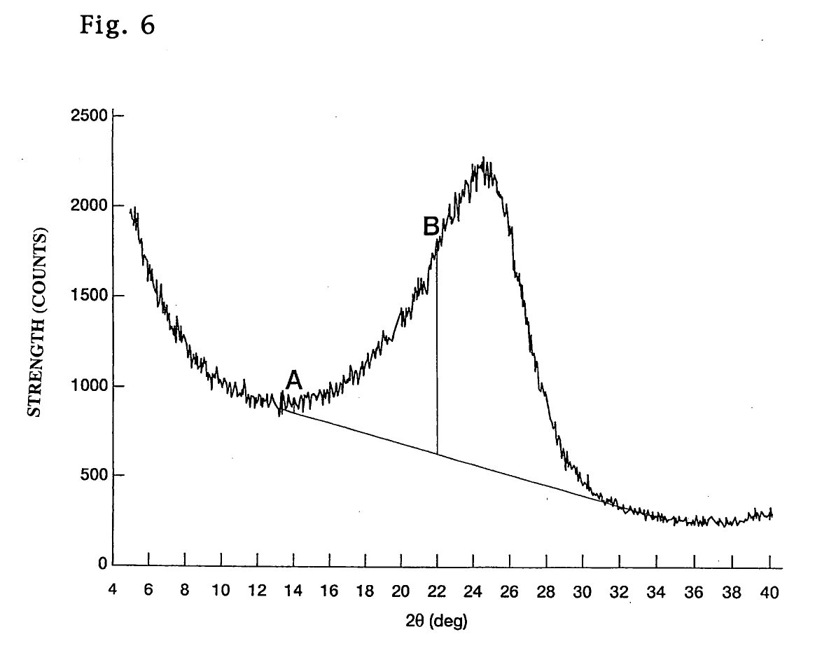

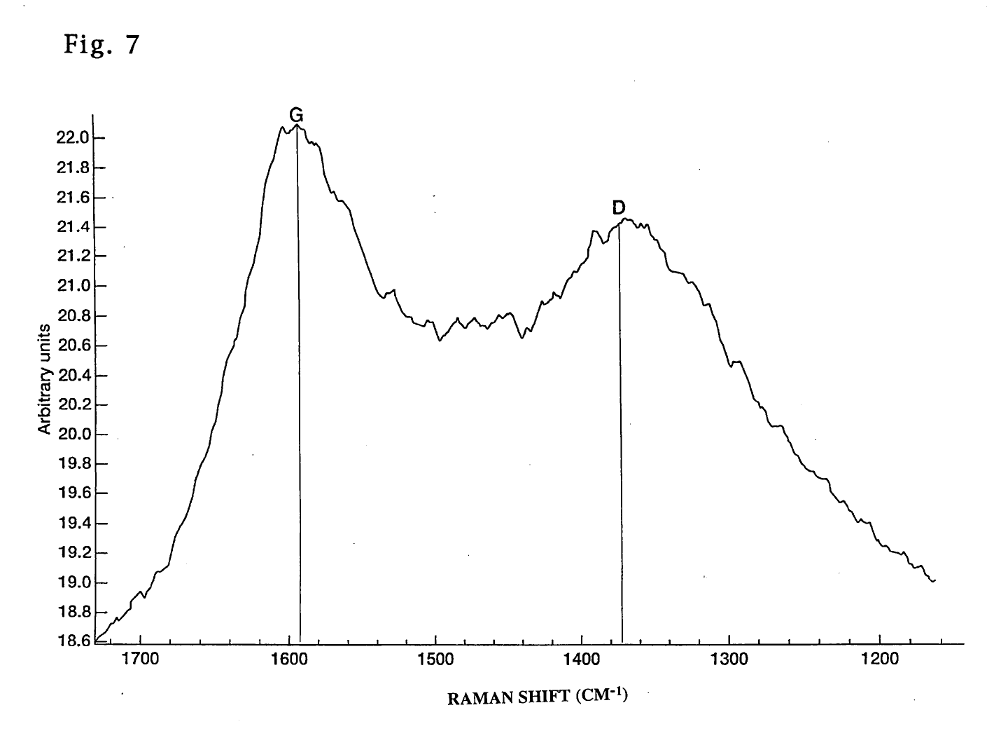

X-ray diffraction, Raman spectrum and volume electrical resistance of a commercial carbon black (trade name: CF9, produced by Mitsubishi Chemical Corporation) were measured. In X-ray diffraction, there was a strong peak at the diffraction angle close to 23-27° (see FIG. 6). In Raman spectrum, peaks were present at 1,590 cm⁻¹ and 1,360 cm⁻¹ (see FIG. 7), and I(D)/I(G) was 0.78. Also, a volume electrical resistance of this carbon black was 1 Ω·cm (under pressure of 120 kgf/cm²).

What is claimed is:

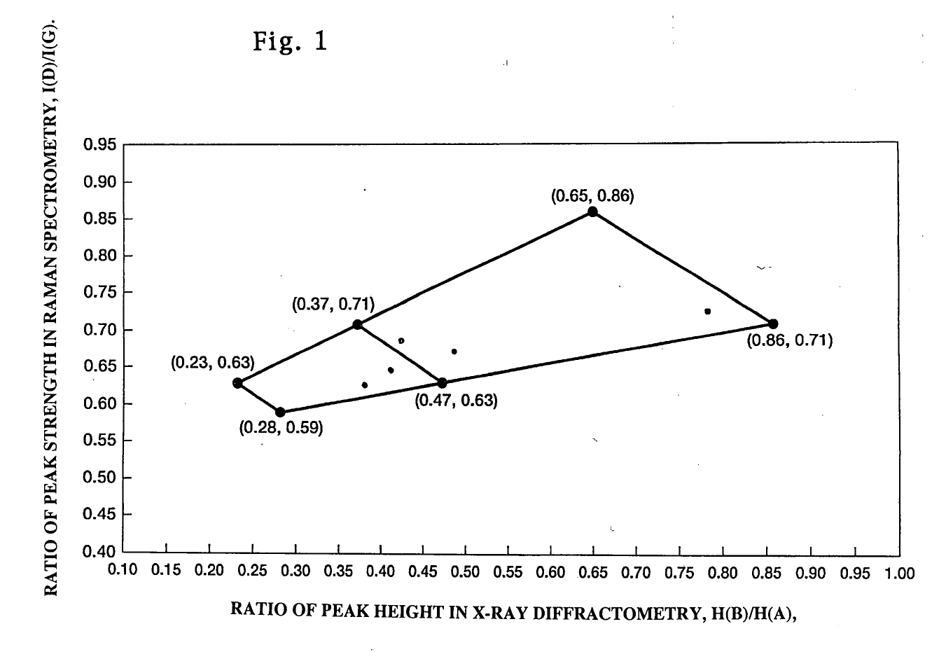

1. A carbon material which is insoluble in organic solvents and has a peak height ratio H(B)/H(A) of 0.2 to 0.9, wherein H(A) represents a height of the strongest peak at the diffraction angle 2 θ of 12-16° and H(B) represents a height of the peak at 2 θ=22° in the X-ray diffractometry using CuKα-rays.
in FIG. 1.

2. A carbon material according to claim 1, which has a volume electrical resistance of not less than 1 Ω·cm when measured by filling 1 g of the carbon material in a 2 cm diameter cylindrical cell with four-probe electrodes and applying a pressure of 120 kgf/cm2 thereto.

3. A carbon material according to claim 1, wherein as a property to be insoluble in organic solvents, the weight difference of the carbon material after the treatment is not more than 5%, where 90 times by weight of 1,2,4-trimethylbenzene is added to the carbon material and the obtained mixture is stirred, filtered and then vacuum dried at 150° C. for 10 hours.

4. A carbon material which is insoluble in organic solvents, and has a peak height ratio H(B)/H(A) and a peak strength ratio I(D)/I(G) which fall within the region defined by four points: (X, Y)=(0.86, 0.71), (0.65, 0.86), (0.28, 0.59) and (0.23, 0.63) in the coordinate system shown in FIG. 1 where the peak height ratio H(B)/H(A) is plotted as the X-axis and the peak strength ratio I(D)/I(G) as the Y-axis, wherein H(A) represents a height of the strongest peak at the diffraction angle 2 θ of 12-16° and H(B) represents a height of the peak at 2 θ=22° in the X-ray diffractometry using CuKα-rays, and I(G) represents a peak strength in the band of G1590±20 cm⁻¹ and I(D) represents a peak strength in the band D1340±40 cm⁻¹ in the Raman spectrometry at the excitation wavelength of 5145 Å.

5. A carbon material according to claim 4, wherein the H(B)/H(A) value and I(D)/I(G) value fall within the region defined by four points: (X, Y)=(0.47, 0.63), (0.37, 0.71), (0.28, 0.59) and (0.23, 0.63) in the coordinate system shown in FIG. 1.

6. A carbon material according to claim 4, which has a volume electrical resistance of not less than 1 Ω·cm when measured by filling 1 g of the carbon material in a 2 cm diameter cylindrical cell with four-probe electrodes and applying a pressure of 120 kgf/cm2 thereto.

7. A carbon material according to claim 4, wherein as a property to be insoluble in organic solvents, the weight difference of the carbon material after the treatment is not more than 5%, where 90 times by weight of 1,2,4-trimethylbenzene is added to the carbon material and the obtained mixture is stirred, filtered and then vacuum dried at 150° C. for 10 hours.

8. A process for producing the carbon material as defined in claim 1, comprising feeding a hydrocarbon-containing compound as a raw material and an oxygen-containing gas into a reaction furnace through delivery ports provided in the reaction furnace to burn the hydrocarbon-containing compound, collecting soot as produced, and contacting the collected soot with an organic solvent, wherein upon producing the soot, the hydrocarbon-containing compound and the oxygen-containing gas are delivered through the respective delivery ports at average delivery rates of from more than 75 cm/sec to 1,000 cm/sec, while maintaining an inside pressure of the reaction furnace in the range of 20 to 100 Torr, and upon burning the hydrocarbon-containing compound, an atomic ratio of carbon element in the hydrocarbon-containing compound to oxygen element in the oxygen-containing gas is set to the range of 0.89 to 1.56.

9. A process for producing the carbon material as defined in claim 1, comprising feeding a hydrocarbon-containing compound as a raw material and an oxygen-containing gas into a reaction furnace through delivery ports provided in the reaction furnace to burn the hydrocarbon-containing compound, collecting soot as produced, and contacting the collected soot with an organic solvent, wherein upon producing the soot, the hydrocarbon-containing compound and the oxygen-containing gas are delivered through the respective delivery ports at average delivery rates of from more than 75 cm/sec to 300 cm/sec, while maintaining an inside pressure of the reaction furnace in the range of 20 to 100 Torr, and upon burning the hydrocarbon-containing compound, an atomic ratio of carbon element in the hydrocarbon-containing compound to oxygen element in the oxygen-containing gas is set to the range of 0.89 to 1.05.

10. A process for producing the carbon material as defined in claim 1, comprising feeding a hydrocarbon-containing gas as a raw material and an oxygen-containing gas into a reaction furnace through delivery ports provided in the reaction furnace to burn the hydrocarbon-containing gas, collecting soot as produced, and contacting the collected soot with an organic solvent, wherein upon producing the soot, the hydrocarbon-containing gas and the oxygen-containing gas are delivered through the respective delivery ports at average delivery rates of from more than 75 cm/sec to 1,000 cm/sec, while maintaining an inside pressure of the reaction furnace in the range of 20 to 100 Torr, and upon burning the hydrocarbon-containing gas, an atomic ratio of carbon element in the hydrocarbon-containing gas to oxygen element in the oxygen-containing gas is set to the range of 0.89 to 1.56; and after contacting the soot with the organic solvent and then cooling the resultant carbon material to a temperature of not more than 100° C., the carbon material is exposed to atmosphere.

11. A process for producing the carbon material as defined in claim 4, comprising feeding a hydrocarbon-containing compound as a raw material and an oxygen-containing gas into a reaction furnace through delivery ports provided in the reaction furnace to burn the hydrocarbon-containing compound, collecting soot as produced, and contacting the collected soot with an organic solvent, wherein upon producing the soot, the hydrocarbon-containing compound and the oxygen-containing gas are delivered through the respective delivery ports at average delivery rates of from more than 75 cm/sec to 1,000 cm/sec, while maintaining an inside pressure of the reaction furnace in the range of 20 to 100 Torr, and upon burning the hydrocarbon-containing compound, an atomic ratio of carbon element in the hydrocarbon-containing compound to oxygen element in the oxygen-containing gas is set to the range of 0.89 to 1.56.

12. A process for producing the carbon material as defined in claim 4, comprising feeding a hydrocarbon-containing compound as a raw material and an oxygen-containing gas into a reaction furnace through delivery ports provided in the reaction furnace to burn the hydrocarbon-containing compound, collecting soot as produced, and contacting the collected soot with an organic solvent, wherein upon producing the soot, the hydrocarbon-containing compound and the oxygen-containing gas are delivered through the respective delivery ports at average delivery rates of from more than 75 cm/sec to 300 cm/sec, while maintaining an inside pressure of the reaction furnace in the range of 20 to 100 Torr, and upon burning the hydrocarbon-containing compound, an atomic ratio of carbon element in the hydrocarbon-containing compound to oxygen element in the oxygen-containing gas is set to the range of 0.89 to 1.05.

13. A process for producing the carbon material as defined in claim 4, comprising feeding a hydrocarbon-containing gas as a raw material and an oxygen-containing gas into a reaction furnace through delivery ports provided in the reaction furnace to burn the hydrocarbon-containing gas, collecting soot as produced, and contacting the collected soot with an organic solvent, wherein upon producing the soot, the hydrocarbon-containing gas and the oxygen-containing gas are delivered through the respective delivery ports at average delivery rates of from more than 75 cm/sec to 1,000 cm/sec, while maintaining an inside pressure of the reaction furnace in the range of 20 to 100 Torr, and upon burning the hydrocarbon-containing gas, an atomic ratio of carbon element in the hydrocarbon-containing gas to oxygen element in the oxygen-containing gas is set to the range of 0.89 to 1.56; and after contacting the soot with the organic solvent and then cooling the resultant carbon material to a temperature of not more than 100° C., the carbon material is exposed to atmosphere.
